(19) United States
(12) Patent Application Publication
(10) Pub. No.: US 2009/0142508 A1
(43) Pub. Date: Jun. 4, 2009

(54) Process for making biomedical devices

(76) Inventors: Yu-Chin Lai, Pittsford, NY (US); Weihong Lang, Amston, CT (US)

Correspondence Address: Bausch & Lomb Incorporated, One Bausch & Lomb Place, Rochester, NY, 14604-2701, US

(21) Appl. No.: 12/271,541

(22) Filed: Nov. 14, 2008

Related U.S. Application Data
(60) Provisional application No. 60/991,024, filed on Nov. 29, 2007.

(51) Int. Cl. B05D 5/06; C08F 2/48

(52) U.S. Cl. 427/508; 427/162

(57) ABSTRACT

A process for treating a medical device involves:

(a) treating a silicon-containing biomedical device with an organic solvent that swells the device, and treating the device with a hydrophilic, monomeric material; and

(b) exposing the biomedical device and the hydrophilic, monomeric material to heat or light radiation to polymerize the hydrophilic, monomeric material.

This application claims the benefit of Provisional Patent Application No. 60/991,024 filed Nov. 29, 2007 which is incorporated by reference herein.

### FIELD OF THE INVENTION

The present invention relates to a process for making polymeric, silicon-containing biomedical devices, particularly ophthalmic devices including contact lenses, intraocular lenses and ophthalmic implants.

### BACKGROUND OF THE INVENTION

Hydrogels represent a desirable class of materials for the manufacture of various biomedical devices, including contact lenses. A hydrogel is a hydrated cross-linked polymeric system that contains water in an equilibrium state. Hydrogel lenses offer desirable biocompatibility and comfort. A silicone hydrogel is a hydrogel material including a silicone-containing monomer, the silicone containing monomer imparting higher oxygen permeability to the resultant hydrogel copolymer.

In a typical process for the manufacture of hydrogel polymeric ophthalmic devices, such as contact lenses, a composition containing a mixture of lens-forming monomers is charged to a mold and cured to polymerize the lens-forming monomers and form a shaped article. In the case of a silicone hydrogel, the lens-forming monomer mixture includes a silicon-containing monomer. This monomer mixture may further include a diluent, in which case the diluent remains in the resulting polymeric article. Additionally, some of these lens-forming monomers may not be fully polymerized, and oligomers may be formed from side reactions of the monomers, these unreacted monomers and oligomers remaining in the polymeric article. Such residual materials may affect optical clarity or irritate the eye when the ophthalmic article is worn or implanted, so generally, the articles are extracted to remove the residual materials. Hydrophilic residual materials can be extracted by water or aqueous solutions, whereas hydrophobic residual materials generally involve extraction with an organic solvent. One common organic solvent is isopropanol, a water-miscible organic solvent. Following extraction, the hydrogel lens article is hydrated by soaking in water or an aqueous solution, which may also serve to replace the organic solvent with water. The molded device can be subjected to machining operations such as lathe cutting, buffing, and polishing, as well as packaging and sterilization procedures.

An example of such a process for silicone hydrogel contact lenses is found in U.S. Pat. No. 5,260,000 (Nandu) et al., where silicone hydrogel contact lenses are cast from monomeric mixtures including n-nonanol or n-hexanol as a diluent, and subsequently extracted with isopropanol to remove any remaining diluent as well as unreacted monomers and oligomers.

The present invention provides a process for incorporating a hydrophilic polymer into a silicon-containing biomedical device. The hydrophilic polymer migrates to the device surface, rendering the surface more wettable, lubricious and biocompatible. In some cases, the hydrophilic polymer may be gradually released from the device over time, or may form an interpenetrating network with the device polymeric matrix.

Numerous publications disclose the inclusion of NVP as a lens-forming monomer in a silicone hydrogel contact lens. Examples include U.S. Pat. Nos. 5,260,000 and 5,486,579. This invention incorporates a longer-chained hydrophilic polymer, such as a PVP polymer, into the lens polymeric matrix.

U.S. Pat. No. 6,367,929 discloses adding to hydrophilic polymer, such as PVP, into a mixture of lens-forming monomers, and polymerizing the lens-forming monomers to entrap the hydrophilic polymer therein. However, it is difficult to mix PVP, especially larger amounts of PVP, with many silicone hydrogel lens-forming monomer mixtures, since such lens-forming mixtures may be highly hydrophobic. When a hydrophilic polymer such as PVP is not sufficiently mixed with the lens-forming monomers, the resultant lens is cloudy and unacceptable as an ophthalmic lens. The present invention is suitable for a much wider variety of silicon-containing device materials.

### SUMMARY OF THE INVENTION

This invention provides a process for treating a medical device comprising, sequentially: (a) treating a silicon-containing biomedical device with an organic solvent that swells the device, and treating the device with a hydrophilic, monomeric material; and (b) exposing the biomedical device and the hydrophilic, monomeric material to heat or light radiation to polymerize the hydrophilic, monomeric material.

The process may further comprise removing the organic solvent, whereby polymerized hydrophilic material remains retained in the device.

In step (a), the device may be treated simultaneously with a solution containing the organic solvent and the hydrophilic, monomeric material. Alternately, the process may comprise, sequentially: (a) treating a silicon-containing biomedical device with an organic solvent that swells the device; (a′) treating the device with a hydrophilic, monomeric material; and (b) exposing the biomedical device and the hydrophilic, monomeric material to heat or light radiation to polymerize the hydrophilic, monomeric material. Step (a′) may include soaking the device in an aqueous solution comprising the hydrophilic, monomeric material.

Step (b) may include autoclaving the device containing the hydrophilic, monomeric material.

Preferably, step (a) swells the device swells in volume by at least 30%, more preferably at least 50%, or even at least 100%. Preferably, the device shrinks in volume as the hydrophilic, monomeric material replaces the organic solvent in the device.

The invention is suitable for contact lenses, especially, silicone hydrogel contact lenses.

The hydrophilic, monomeric material may include at least one member selected from the group consisting of N-vinylpyrrolidone, ethylenically unsaturated PVP, ethylenically unsaturated PVA, ethylenically unsaturated PAA, and ethylenically unsaturated PEO. The hydrophilic, monomeric material may have an Mn of at least 500, more preferably, at least 1000, or even at least 3000. The hydrophilic, monomeric material may include (meth)acrylate functionality, such as (meth)acrylated PVP.

Step (a) may involve soaking the device in an aqueous solution comprising the hydrophilic, monomeric material and an initiator.

Step (a) may involve soaking the device in isopropanol, ethanol, or an aqueous mixture thereof.

According to a preferred embodiment, the process comprises, sequentially: (a) soaking a silicon-containing contact lens in a solution including an organic solvent that swells the device in volume by at least 30%; (b) soaking the contact lens in an aqueous solution including a hydrophilic, monomeric material, whereby the hydrophilic, monomeric material replaces the organic solvent in the lens and shrinks the lens in volume; and (c) exposing the contact lens with the hydrophilic, monomeric material absorbed therein to heat or light radiation to polymerize the hydrophilic, monomeric material.

Step (b) may be repeated with aqueous solutions including sequentially lower amounts of the hydrophilic monomeric material.

### DETAILED DESCRIPTION OF VARIOUS PREFERRED EMBODIMENTS

The present invention provides a method for silicon-containing biomedical devices, especially ophthalmic biomedical devices. The term “biomedical device” means a device intended for direct contact with living tissue. The term “ophthalmic biomedical device” means a device intended for direct contact with ophthalmic tissue, including contact lenses, intraocular lenses and ophthalmic implants. In the following description, the process is discussed with particular reference to silicone hydrogel contact lenses, a preferred embodiment of this invention, but the invention may be employed for extraction of other polymeric biomedical devices.

Hydrogels comprise a hydrated, crosslinked polymeric system containing water in an equilibrium state. Accordingly, hydrogels are copolymers prepared from hydrophilic monomers. In the case of silicone hydrogels, the hydrogel copolymers are generally prepared by polymerizing a mixture containing at least one lens-forming silicone-containing monomer and at least one lens-forming hydrophilic monomer. Either the silicone-containing monomer or the hydrophilic monomer may function as a crosslinking agent (a crosslinking agent being defined as a monomer having multiple polymerizable functionalities), or alternately, a separate crosslinking agent may be employed in the initial monomer mixture from which the hydrogel copolymer is formed. (As used herein, the term “monomer” or “monomeric” and like terms denote relatively low molecular weight compounds that are polymerizable by free radical polymerization, as well as higher molecular weight compounds also referred to as “prepolymers”, “macromonomers”, and related terms.) Silicone hydrogels typically have a water content between about 10 to about 80 weight percent.

Examples of useful lens-forming hydrophilic monomers include: amides such as N,N-dimethylacrylamide and N,N-dimethylmethacrylamide; cyclic lactams such as N-vinyl-2-pyrrolidone; (meth)acrylated alcohols, such as 2-hydroxyethyl methacrylate, 2-hydroxyethyl acrylate and glyceryl methacrylate; (meth)acrylated poly(ethylene glycol)s; (meth)acrylic acids such as methacrylic acid and acrylic acid; and aziactone-containing monomers, such as 2-isopropenyl-4,4-dimethyl-2-oxazolin-5-one and 2-vinyl-4,4-dimethyl-2-oxazolin-5-one. (As used herein, the term “(meth)” denotes an optional methyl substituent. Thus, terms such as “(meth)acrylate” denotes either methacrylate or acrylate, and “(meth)acrylic acid” denotes either methacrylic acid or acrylic acid.) Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277, the disclosures of which are incorporated herein by reference. Other suitable hydrophilic monomers will be apparent to one skilled in the art.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicone-containing monomers include bulky polysiloxanylalkyl(meth)acrylic monomers. An example of such monofunctional, bulky polysiloxanylalkyl(meth)acrylic monomers are represented by the following Formula I:

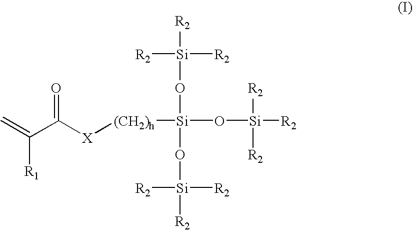

wherein:

X denotes —O— or —NR—;

each R₁ independently denotes hydrogen or methyl;

each R₂ independently denotes a lower alkyl radical, phenyl radical or a group represented by

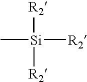

wherein each R₂′ independently denotes a lower alkyl or phenyl radical; and h is 1 to 10. One preferred bulky monomer is 3-methacryloxypropyl tris(trimethyl-siloxy)silane or tris(trimethylsiloxy)silylpropyl methacrylate, sometimes referred to as TRIS.

Another class of representative silicone-containing monomers includes silicone-containing vinyl carbonate or vinyl carbamate monomers such as: 1,3-bis[4-vinyloxycarbonyloxy)but-1-yl]tetramethyldisiloxane; 1,3-bis[4-vinyloxycarbonyloxy)but-1-yl]polydimethylsiloxane; 3-(trimethylsilyl)propyl vinyl carbonate; 3-(vinyloxycarbonylthio)propyl[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicone-containing vinyl carbonate or vinyl carbamate monomers are represented by Formula II:

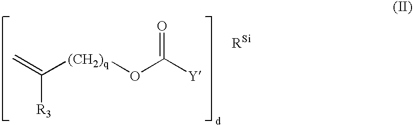

wherein:

Y′ denotes —O—, —S— or —NH—;

R^{Si} denotes a silicone-containing organic radical;

R₃ denotes hydrogen or methyl;

d is 1, 2, 3 or 4; and q is 0 or 1.

Suitable silicone-containing organic radicals R^{Si} include the following:

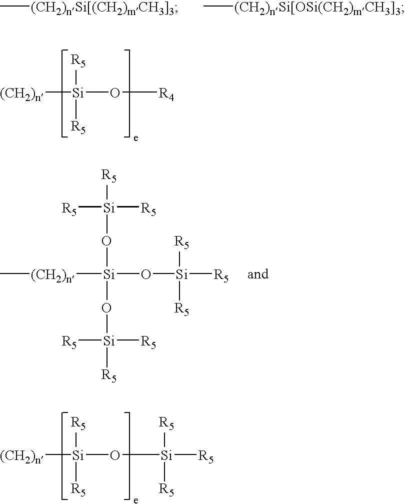

wherein:

R₄ denotes

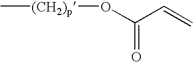

wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III:

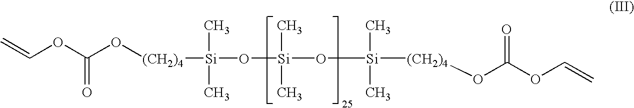

Another class of silicone-containing monomers includes polyurethane-polysiloxane macromonomers (also sometimes referred to as prepolymers), which may have hard-soft-hard blocks like traditional urethane elastomers. Examples of silicone urethane monomers are represented by Formulae IV and V:

E(*D*A*D*G)a*D*A*D*E′; or (IV)

E(*D*G*D*A)a*D*G*D*E′; (V)

wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

denotes a urethane or ureido linkage;

a is at least 1;

A denotes a divalent polymeric radical of Formula VI:

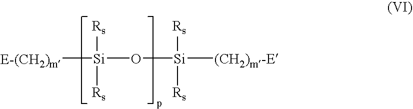

wherein:
each Rₛ independently denotes an alkyl or fluoro-substituted alkyl group having 1 to 10 carbon atoms which may contain ether linkages between carbon atoms;
m′ is at least 1; and
p is a number which provides a moiety weight of 400 to 10,000;
each of E and E′ independently denotes a polymerizable unsaturated organic radical represented by Formula VII:

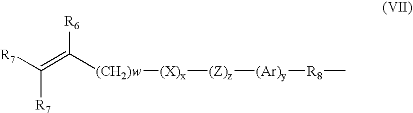

wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicone-containing urethane monomer is represented by Formula (VIII):

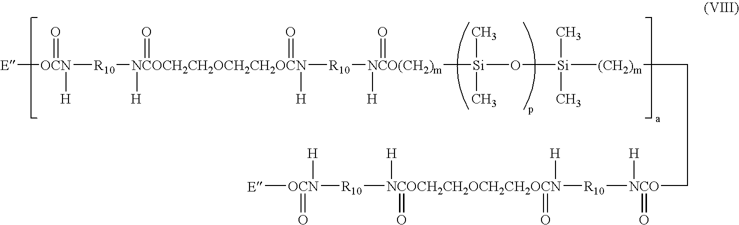

wherein m is at least 1 and is preferably 3 or 4, a is at least I and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

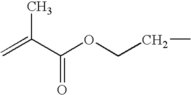

A preferred silicone hydrogel material comprises (based on the initial monomer mixture that is copolymerized to form the hydrogel copolymeric material) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicone-containing vinyl carbonate or vinyl carbamate or a polyurethane-polysiloxane having one or more hard-soft-hard blocks and end-capped with a hydrophilic monomer.

Specific examples of contact lens materials for which the present invention is useful are taught in U.S. Pat. No. 6,891,010 (Kunzler et al.); U.S. Pat. No. 5,908,906 (Kunzler et al.); U.S. Pat. No. 5,714,557 (Kunzler et al.); U.S. Pat. No. 5,710,302 (Kunzler et al.); U.S. Pat. No. 5,708,094 (Lai et al.); U.S. Pat. No. 5,616,757 (Bambury et al.); U.S. Pat. No. 5,610,252 (Bambury et al.); U.S. Pat. No. 5,512,205 (Lai); U.S. Pat. No. 5,449,729 (Lai); U.S. Pat. No. 5,387,662 (Kunzler et al.); U.S. Pat. No. 5,310,779 (Lai); and U.S. Pat. No. 5,260,000 (Nandu et al.), the disclosures of which are incorporated herein by reference.

Generally, the monomer mixtures may be charged to a mold, and then subjected to heat and/or light radiation, such as UV radiation, to effect curing, or free radical polymerization, of the monomer mixture in the mold. Various processes are known for curing a monomeric mixture in the production of contact lenses or other biomedical devices, including spincasting and static casting. Spincasting methods involve charging the monomer mixture to a mold, and spinning the mold in a controlled manner while exposing the monomer mixture to light. Static casting methods involve charging the monomer mixture between two mold sections forming a mold cavity providing a desired article shape, and curing the monomer mixture by exposure to heat and/or light. In the case of contact lenses, one mold section is shaped to form the anterior lens surface and the other mold section is shaped to form the posterior lens surface. If desired, curing of the monomeric mixture in the mold may be followed by a machining operation in order to provide a contact lens or article having a desired final configuration. Such methods are described in U.S. Pat. Nos. 3,408,429, 3,660,545, 4,113,224, 4,197,266, 5,271,875, and 5,260,000, the disclosures of which are incorporated herein by reference. Additionally, the monomer mixtures may be cast in the shape of rods or buttons, which are then lathe cut into a desired shape, for example, into a lens-shaped article.

Following casting of the device, the article is typically extracted to remove undesired extractables from the device. For example, in the case of contact lenses made from a silicone hydrogel copolymer, extractables include any remaining diluent, unreacted monomers, and oligomers formed from side reactions of the monomers.

In the process of this invention, the contact lens is treated with an organic solvent, preferably by soaking the lens in the organic solvent. This step serves to extract undesired residual materials in the lens, as in prior extraction processes. In this invention, this step will swell the lens in volume by at least 30%, more preferably by at least 50%, and most preferably by at least 100%, so that in subsequent steps, the hydrophilic, monomeric material may be absorbed into the lens polymeric matrix. It is preferred the contact lens is soaked in the organic solvent, or a solution containing the organic solvent, for sufficient time that the contact lens copolymeric material reaches equilibrium therewith.

Examples of suitable organic solvents are ethanol or isopropanol, which are particularly effective at swelling the contact lens polymeric material. Additional organic solvents are listed in the following table.

| | Flash Point | Vapor Pressure |
|---|---|---|
| Compound | (° C.) | (mmHg@25° C.) |
| Isopropanol | 11 | 20.48 |
| Dipropylene glycol | 137 | 0.01 |
| Dipropylene glycol monomethyl ether | 74 | — |
| Diethylene glycol monobutyl ether | 100 | 0.02 |
| Diethylene glycol monopropyl ether | — | 0.06 |
| Diethylene glycol monoethyl ether | 96 | 0.14 |
| Diethylene glycol monomethyl ether | 83 | 0.17 |
| Diethylene glycol monovinyl ether | 82 | 0.06 |
| Hexylene glycol | 93 | 0.04 |
| 2-methyl-butanol | 43 | 16.57 |
| 3-methyl-butanol | 45 | 2.94 |
| 3-pentanol | 40 | — |
| 4-methyl-2-pentanol | 40 | — |
| 2-methoxy-ethanol | 46 | 8.63 |
| 3-methoxy-1-butanol | 46 | 1.07 |

The treatment of the contact lenses may be effective with a mixture of two or more of the organic solvents, and the organic solvent may be included in an aqueous solution. The contact lenses may be immersed in the organic solvent at or near ambient temperature (25° C.) and pressure conditions (1 atm), or if desired, at elevated temperature or pressure. If desired, this step may be carried out in the receptacle of a contact lens blister package, or in another vessel.

Following treatment of the lens with the organic solvent, the lens is treated with a hydrophilic, monomeric material, preferably by soaking the lens in an aqueous solution containing this hydrophilic, monomeric material. This step serves to replace the organic solvent with the hydrophilic, monomeric material (and water, when an aqueous solution is used). And since the lens polymeric material is swollen from the previous treatment with organic solvent, the lens polymeric material is able to absorb the hydrophilic material therein; this results in shrinking of the lens polymeric material and the consequential retention of the hydrophilic material therein.

Suitable hydrophilic, monomeric materials include ethylenically unsaturated PVP, ethylenically unsaturated PVA (polyvinyl alcohol), ethylenically unsaturated PAA (polyacrylic acid), ethylenically unsaturated PEO (polyethyleneoxy), ethylenically unsaturated copolymers of PVP, PVA, PAA and PEO, and mixtures thereof. This material may be provided in water or an aqueous solution such as buffered saline solution. Preferred hydrophilic, monomeric material includes (meth)acrylate functionality, such as (meth)acrylated PVP, (meth)acrylated PVA, (meth)acrylated PAA, (meth)acrylated PEO, and the like.

Suitable hydrophilic, monomeric materials include lower molecular weight hydrophilic monomers, such as NVP, Hema or DMA.

If desired, the treatment of the lens with the hydrophilic, monomeric material may be accomplished in a series of sequential steps. In this series, the lens is treated sequentially with several different solutions, where subsequent solutions have lowered amounts of the hydrophilic, monomeric material.

Optionally, an initiator may be included in the treatment solution including the hydrophilic, monomeric material, to facilitate polymerization thereof in subsequent steps.

After treatment of the contact lens with the hydrophilic, monomeric material, the contact lens is treated with heat or light radiation to polymerize the hydrophilic, monomeric material. This serves to help ensure this material, now having the form of a longer chained polymer, is retained in the lens polymeric matrix.

Following polymerization of the hydrophilic, monomeric material, the contact lens is packaged and sterilized (for example, by autoclaving) according to conventional methods. Alternately, the hydrophilic, monomer material may be polymerized and sterilized simultaneously, for example, by autoclaving.

The following examples illustrate various preferred embodiments of this invention. The following abbreviations are used in the illustrative examples.
I4D5S4H—a polyurethane-based prepolymer endcapped with 2-methacryloxyethyl (derived from isophorone diisocyanate, diethylene glycol, a polydimethylsiloxanediol, and 2-hydroxyethyl methacrylate according to U.S. Pat. No. 5,034,461) and described more fully in Example 3 below.
TRIS—3-methacryloxypropyl tris(trimethylsiloxy)silane
DMA—N,N-dimethylacrylamide
NVP—N-vinyl pyrrolidone
PVP—poly(N-vinyl pyrrolidone)
HemaVC—methacryloxyethyl vinyl carbonate
Hema—2-hydroxyethylmethacrylate
IMVT—1,4-bis(4-(2-methacryloxyethyl)phenylamino)anthraquinone (described in U.S. Pat. No. 4,997,897), a blue visibility-tinting agent
IPA—isopropyl alcohol
AIBN—azobisisobutyronitrile (Vazo-64 initiator)

### EXAMPLE 1

### Synthesis of hydroxyl-Containing poly(N-vinyl pyrrolidone)

To a 1000 ml three-neck, round bottom flask equipped with a reflux condenser and nitrogen inlet tube was added with 900 ml of 2-isopropoxyethanol (813.6 g, 7.812 mol), 30 ml of distilled NVP (31.35 g, 0.282 mol) and 0.317 g (1.930 mmol) of AIBN. The contents were bubbled vigorously with nitrogen for 1 hour. While under moderate nitrogen bubbling and stirring the contents were heated at 80° C. for two days. After stripping solvent under reduced pressure, the hydroxyl functionalized PVP product was recovered. The Mn of PVP was determined by titration to be above 1357.

### EXAMPLE 2

### Synthesis of Acrylated PVP

A 250 ml, round bottom flask equipped with nitrogen inlet tube was set up. Under the flow of dry nitrogen, hydroxyl functionalized PVP of Example 1 (16.95 g, approximately 12.49 mmol) and 200 ml anhydrous THF were added in succession. The flask was then cooled with an ice-water bath. Under stirring, triethanolamine (2.720 g, 26.880 mmol) was then added followed by adding dropwise acryloyl chloride (2.333 g; 25.776 mmol) to the mixture. The reaction mixture was then allowed to warm to ambient temperature and kept stirred for one day. DI water (25 mL) was added to the reaction mixture to give a clear solution. After ultrafiltration, solvent was removed under vacuum to give a pale yellow solid.

### EXAMPLE 3

### Preparation of a polydimethylsiloxane-Based polyurethane polymer (I4D5S4H)

In a dry 1000 ml three-neck round bottom flask, under the flow of dry nitrogen, was added PDMS-diol (208.54 g; 51.57 mmol), anhydrous dichloromethane (DCM, 400 ml), dibutyltin dilaureate (DBTDL, 0.69 g), and isophoronediisocyante (IPDI, 23.149 g; 104.14 mmol). The contents were refluxed overnight. After titration, diethylene glycol (DEG, 4.769 g; 44.94 mmol) was added to the flask and refluxed overnight. Again after titration, the reaction mixture was cooled down to room temperature. 32 mg of inhibitor was added and then 2-hydroxyethyl methacrylate (HEMA, 1.751 g) was added to the reaction mixture, and the mixture was stirred until there was no isocyanate functionality determined. Solvent was removed and I4D5S4H was recovered.

### EXAMPLE 4

### Lens Casting

A monomer mixture was prepared from the components listed in Table 1. The amounts in Table 1 are parts by weight percent unless otherwise noted. Dosages of the monomer mixture were placed between polypropylene anterior and posterior contact lens molds, and cured by exposure to UV radiation. Following curing, the posterior mold sections are removed, and the contact lenses were released from the anterior mold sections.

As controls, some of the lenses were then extracted in IPA for 2 hours, then hydrated in water, and then saturated in borate buffered saline. The lenses had the following properties: water content 34.7%; modulus 84 g/mm²; tear strength 4 g/mm.

TABLE 1

| Component | Parts by Weight |
|---|---|
| I4D5S4H | 60 |
| TRIS | 15 |
| DMA | 7 |
| NVP | 22 |
| HemaVC | 1 |
| Hema | 2.5 |
| n-hexanol | 10 |
| IMVT | 150 ppm |
| Darocur ™ 1173 Initiator | 0.5 |

### EXAMPLE 5

### Contact Lens Treatment

A solution of acrylated PVP from Example 2 in dichloromethane/isopropanol at 1:5:1 weight ratio was prepared. AIBN was added at 1 weight %, based on total weight of the solution. Three contact lenses of Example 4, prior to extraction with IPA, were dipped into this solution; the lenses had a combined weight of 0.07499 g. The lenses were then thermally polymerized in an oven, followed by rinsing and drying. The lenses increased in mass by 0.4%, and water content was 35.1%, which represented a slight increase from control. These treated lenses were observed to be much more lubricious than the untreated control lenses.

### EXAMPLE 6

### Contact Lens Treatment

A solution of NVP and IPA at a ratio of 1:2 was prepared. AIBN was added at 1 weight %, based on total weight of the solution. Then three lenses of Example 4, prior to extraction with IPA and having a dry weight of 0.07447 g, were dipped into this solution and then thermally polymerized in an oven. Lenses were then rinsed and dried and found to have a weight gain of 15%. Water content of the lens was 49.8%. These treated lenses were observed to be more lubricious than the untreated control lenses and more lubricious than the lenses of Example 5.

### EXAMPLE 7

### Contact Lens Treatment

Lenses as cast in Example 4 are extracted first with isopropanol for 2 hours, then transferred to an IPA solution containing 1% of acrylated PVP of Example 2, and 0.01% of AIBN. Subsequently, the lenses are transferred to borate buffered saline solution and autoclaved for one cycle.

### EXAMPLE 8

### Lens Treatments

Lenses as cast in Example 4 are extracted first with isopropanol containing 1% of acrylated PVP of example 2 and 0.01% of AIBN. Subsequently, the lenses are transferred to borate buffered saline solution and autoclaved for one cycle.

### EXAMPLE 9

### Contact Lens Treatment

Lenses as cast in Example 4 are extracted first with isopropanol for 2 hours, and then are transferred to an IPA solution containing 1% of NVP and 0.01% of AIBN. After that, the lenses are transferred to borate buffered saline solution and autoclaved for 1 cycle.

### EXAMPLE 10

### Contact Lens Treatment

Lenses as cast in Example 4 are extracted first with isopropanol containing 1% of NVP and 0.01% of AIBN. After that, the lenses are transferred to borate buffered saline solution and autoclaved for 1 cycle.

### EXAMPLE 11

### Contact Lens Treatment

A first solution is prepared by combining 20 weight percent of the acrylated PVP of Example 2 and 0.1 weight percent AIBN in isopropanol. A second solution is prepared by taking an aliquot of the first solution and diluting it with 50% by volume of water. A third solution is prepared by taking an aliquot of the second solution and diluting it with 50% by volume of water. A fourth solution is prepared by taking an aliquot of the third solution and diluting it with 50% by volume of water. Contact lenses from Example 4 are placed in the first solution overnight. The lenses are then sequentially soaked in the second, third and fourth solutions, for 60 minutes each. The sequential treatments serve to shrink the lens, with the acrylated PVP remaining in the lens polymeric matrix. Subsequently, the lenses are placed in deionized water and heated to 70-90° C. for 60 minutes to polymerize the acrylated PVP, and then are autoclaved for 30 minutes. The lenses are removed from this solution, and autoclaved in borate buffered saline for 30 minutes.

Having thus described the preferred embodiment of the invention, those skilled in the art will appreciate that various modifications, additions, and changes may be made thereto without departing from the spirit and scope of the invention, as set forth in the following claims.

We claim:

1. A process for treating a medical device comprising, sequentially:
(a) treating a silicon-containing biomedical device with an organic solvent that swells the device, and treating the device with a hydrophilic, monomeric material; and
(b) exposing the biomedical device and the hydrophilic, monomeric material to heat or light radiation to polymerize the hydrophilic, monomeric material.

2. The process of claim 1, further comprising removing the organic solvent, whereby polymerized hydrophilic material remains retained in the device.

3. The process of claim 1, wherein in step (a), the device is treated simultaneously with a solution containing the organic solvent and the hydrophilic, monomeric material.

4. The process of claim 1, comprising, sequentially:
(a) treating a silicon-containing biomedical device with an organic solvent that swells the device;
(a′) treating the device with a hydrophilic, monomeric material; and
(b) exposing the biomedical device and the hydrophilic, monomeric material to heat or light radiation to polymerize the hydrophilic, monomeric material.

5. The process of claim 4, further comprising removing the organic solvent, whereby polymerized hydrophilic material remains retained in the device.

6. The process of claim 1, wherein step (b) includes autoclaving the device containing the hydrophilic, monomeric material.

7. The process of claim 4, wherein step (a) includes soaking the device in a solution comprising organic solvent, and step (a′) includes soaking the device in an aqueous solution comprising the hydrophilic, monomeric material.

8. The process of claim 1, wherein in step (a), the device swells in volume by at least 30%.

9. The process of claim 1, wherein in step (a), the device swells in volume by at least 50%.

10. The process of claim 1, wherein in step (a), the device swells in volume by at least 100%.

11. The process of claim 1, wherein the device shrinks in volume as the hydrophilic, monomeric material replaces the organic solvent in the device.

12. The process of claim 1, wherein the device is a contact lens.

13. The process of claim 1, wherein the device is a silicone hydrogel contact lens.

14. The process of claim 1, wherein the hydrophilic, monomeric material includes at least one member selected from the group consisting of N-vinylpyrrolidone, ethylenically unsaturated PVP, ethylenically unsaturated PVA, ethylenically unsaturated PAA, and ethylenically unsaturated PEO.

15. The process of claim 1, wherein the hydrophilic, monomeric material includes (meth)acrylate functionality.

16. The process of claim 15, wherein the hydrophilic, monomeric material includes (meth)acrylated PVP.

17. The process of claim 1, wherein step (a) includes soaking the device in an aqueous solution comprising the hydrophilic, monomeric material and an initiator.

18. The process of claim 1, wherein step (a) includes soaking the device in isopropanol, ethanol, or an aqueous mixture thereof.

19. The process of claim 1, wherein the hydrophilic, monomeric material has an Mn of at least 500.

20. The process of claim 1, wherein the hydrophilic, monomeric material has an Mn of at least 1000.

21. The process of claim 1, wherein the hydrophilic, monomeric material has an Mn of at least 3000.

22. The process of claim 1, comprising, sequentially:
(a) soaking a silicon-containing contact lens in a solution including an organic solvent that swells the device in volume by at least 30%;
(b) soaking the contact lens in an aqueous solution including a hydrophilic, monomeric material, whereby the hydrophilic, monomeric material replaces the organic solvent in the lens and shrinks the lens in volume; and
(c) exposing the contact lens with the hydrophilic, monomeric material absorbed therein to heat or light radiation to polymerize the hydrophilic, monomeric material.

23. The process of claim 22, wherein step (b) is repeated with aqueous solutions including sequentially lower amounts of the hydrophilic monomeric material.
